(19) United States
(12) Patent Application Publication
(10) Pub. No.: US 2012/0210950 A1
(43) Pub. Date: Aug. 23, 2012

(54) HANDS FREE RESTRAINING DEVICE

(76) Inventors: Mark Stanley, Chino, CA (US); Penelope Akwei, Pasadena, CA (US)

(21) Appl. No.: 13/033,588

(22) Filed: Feb. 23, 2011

(51) Int. Cl. A01K 27/00; A01K 29/00

(52) U.S. Cl. 119/770; 119/795

(57) ABSTRACT

One example embodiment includes a hands free system for restraining an animal. The system includes an armband, where the armband is configured to be attached around at least a portion of the arm of a user. The system also includes a buckle, where the buckle is configured to connect to a leash, allowing the user to restrain an animal.

### CROSS-REFERENCE TO RELATED APPLICATIONS

Not applicable.

### BACKGROUND OF THE INVENTION

A favorite hobby of many pet owners is going for walks with their pet. For example, many dog and cat owners will often take their pet for a walk every day or almost every day. Unfortunately, this can lead to undesirable encounters. For example, pets can attack other animals or people. In addition, pets can become distracted and run away or run into the street where they can be hit and killed. Because of these dangers, many states and cities now have ordinances requiring pets to be on a leash when outdoors.

Many pet owners especially like to jog with their pet. However, this often is difficult to do with a simple leash. In particular, many runners piston their hands back and forth while running. I.e., runners often swing their arms back and forth. This means that the orientation of the runner's hand relative to the pet is continuously changing. This may make restraining the pet difficult, especially if the pet is poorly trained or the change in force confuses the movements of the pet.

Further, a simple leash occupies the hands of the user. This means that the user's hands are not available for other uses such as carrying other objects. That is, many times in our daily lives our hands are full of things to carry. Adding a leash handle to our burdens may be difficult or impossible.

Additionally, there are other conditions which make the use of a simple leash difficult. For example, the disabled often have difficulty in holding a leash. They may be confined to a wheel chair or require crutches or they may have insufficient strength to hold the leash. In these cases, simply moving may require the use of both hands, making it difficult to hold the leash.

There are devices which help control an animal in these conditions. However, they suffer from a number of drawbacks. In particular, there are devices which are made to go around the waist of the user and connect to a leash. However, for a user in a wheelchair, these devices are uncomfortable or present as many problems as they solve. Additionally, any movement by the pet can unbalance the user. This can cause serious injury or harm. Especially if the pet continues to move while the user is lying on the ground, unable to release the pet.

Accordingly, there is a need in the art for a system that allows a user to walk or jog with a pet without using his/her hands. Additionally, there is a need in the art for the system to release quickly if so desired by the user. Further, there is a need in the art for the system to be able to help the user with his/her other burdens.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a hands free system for restraining an animal. The system includes an armband, where the armband is configured to be attached around at least a portion of the arm of a user. The system also includes a buckle, where the buckle is configured to connect to a leash, allowing the user to restrain an animal.

Another example embodiment includes a hands free system for restraining an animal. The system includes an armband. The armband is configured to be attached around at least a portion of the arm of a user and includes neoprene. The system also includes a buckle. The buckle is attached to the armband, is configured to connect to a leash and can swivel relative to the armband. The system further includes a leash. The leash is connected to the buckle and is capable of attaching to an animal or device for controlling the animal.

Another example embodiment includes a hands free system for restraining an animal. The system includes an armband. The armband is configured to be attached around at least a portion of the upper arm of the user, includes neoprene and includes a pocket. The system also includes a buckle. The buckle is attached to the armband, is configured to connect to a leash, can swivel relative to the armband and includes a quick release. The system also includes a leash. The leash is connected to the buckle, is capable of attaching to an animal or device for controlling the animal and includes an elastic portion.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a hands-free system for restraining an animal;

FIG. 2A illustrates an outside of the armband;

FIG. 2B illustrates a side view of the armband;

FIG. 2C illustrate an inside view of the armband;

FIG. 3A illustrates a front view of an example of a leash; and

FIG. 3B illustrates a side view of the example of a leash.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

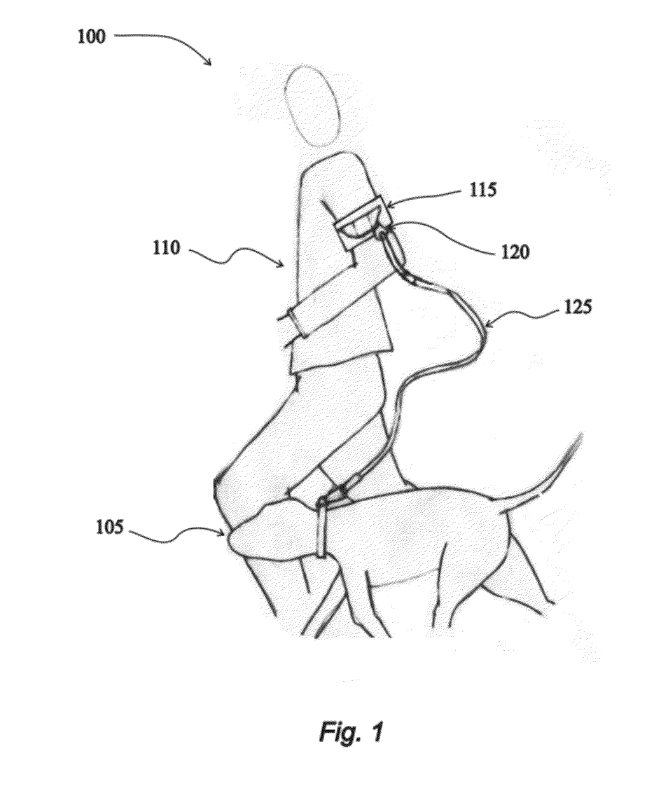

FIG. 1 illustrates an example of a hands-free system 100 for restraining an animal 105. In at least one implementation, the system 100 can be used to restrain the animal 105 while running or jogging or in other environments where the user 110 wishes to restrain the animal 105 without occupying his/her hands. For example, the system 100 can be used by law enforcement officials or the disabled. The system can allow police officers, for example, to restrain a police dog when drawing their weapon.

FIG. 1 shows that the system 100 can include an armband 115. In at least one implementation, the armband 115 is configured to surround a portion of the arm of the user 110. In particular, the user 110 can secure the armband 115 around his/her bicep, thus preserving his/her hands for other uses. One of skill in the art will appreciate that the armband 115, although capable of being secured around the arm, can be secured around other body parts, such as the waist or the leg, without limitation, or around other areas, such as parts of a wheel chair, unless otherwise specified in the claims.

FIG. 1 also shows that the system 100 can include a buckle 120. In at least one implementation, the buckle 120 is attached to the armband 115. In particular, the buckle 120 is configured to attach a leash 125 to the armband 115, as described below. The buckle 120 can include a quick release, allowing the armband to be worn without the leash 125 attached, or to release the leash 125 quickly in an emergency as described below. Further, the buckle 120 can rotate relative to the armband 115 to allow the animal 105 a wide range of motion while being restrained.

FIG. 1 further shows that the system 100 can include a leash 125. In at least one implementation, a leash 125 can connect to an animal 105 for restraint or control. The leash 125 can connect directly to the animal 105, for example looping around the neck of the animal 105, or can connect to a control device on the animal 105. For example, the leash 125 can connect to a collar, harness, halter, muzzle or other control device on the animal 105.

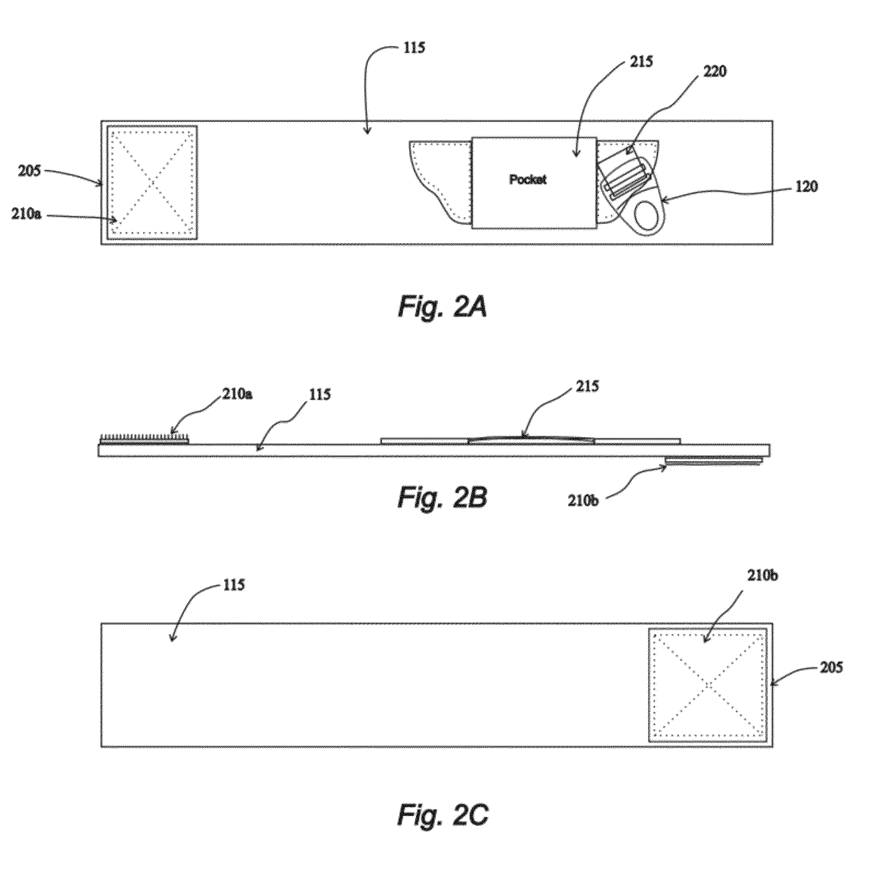

FIGS. 2A, 2B and 2C illustrate an example of an armband 115. FIG. 2A illustrates an outside of the armband 115; FIG. 2B illustrates a side view of the armband 115; and FIG. 2C illustrate an inside view of the armband 115. In at least one implementation, the armband 115 can be secured around a portion of the arm of a user, as described above. The armband 115 can be made of any material suitable for securing around the arm of the user. For example, if the user wishes to use the armband 115 during activities during which the user is likely to sweat, the armband 115 can be made of materials such as neoprene which are designed to wick sweat away from the user's body. Additionally or alternatively, the armband 115 can be made of other fabrics, such as cotton or wool.

In at least one implementation, the armband 115 can be sized such that it is able to wrap around the arm of the user and be secured in position. For example, the armband 115 can be between 10.4 inches and 15.6 inches wide in order to fit around the arm of the average user. For instance, the armband 115 can be approximately 13 inches wide. Additionally or alternatively, the armband 115 can be between 2.4 inches and 3.6 inches tall. For example, the armband 115 can be approximately 3 inches tall. As used in the specification and the claims, the term approximately shall mean that the value is within 10% of the stated value, unless otherwise specified.

FIGS. 2A, 2B and 2C show that the armband 115 can include an attachment 205. In at least one implementation, the attachment 205 can be used to secure a first end of the armband 115 to a second end of the armband 115. For example, the attachment 205 can include a hook and loop fastener. In particular, it can include a first layer 210a, a “hook” side, which includes a piece of fabric covered with tiny hooks, and a second layer 210b, a “loop” side, which includes smaller and “hairier” loops. When the first layer 210a and the second layer 210b are pressed together, the hooks catch in the loops and hold the pieces together. Additionally or alternatively, the attachment 205 can include zippers, button, snaps, ties, straps or any other device for securing the armband 115.

FIGS. 2A, 2B and 2C also show that the armband 115 can include a pocket 215. In at least one implementation, the pocket 215 can include a piece of fabric attached to armband 115. The fabric can be the same material as the armband 115 or a different fabric, as desired. The pocket 215 can be sized to allow the user to place personal items within the pocket 215. For example, the pocket 215 can be between 2.1 inches and 3.15 inches wide. For instance, the pocket 215 can be approximately 2.625 inches wide. Additionally or alternatively, the pocket 215 can be between 1.8 inches and 2.7 inches tall. For example, the pocket 215 can be approximately 2.25 inches tall. In at least one implementation, the pocket 215 can include other features. For example, the pocket 215 can include multiple pockets of various size configured to hold different possessions. Additionally or alternatively, the pocket 215 can include a latch or overhang intended to keep the possessions of the user within the pocket, even when the armband 115 is being moved aggressively, as when the user is jogging or running.

FIGS. 2A, 2B and 2C further show that the armband 115 can include a buckle 120. In at least one implementation, the buckle 120 can be configured to allow a leash to attach to the armband 115. In particular, the buckle 120 can include a quick release for quickly attaching or detaching the leash from the armband 115. Additionally or alternatively, the buckle 120 can allow the leash to rotate relative to the armband 115. Allowing the leash to rotate relative to the armband 115 can provide greater range of movement and can prevent the armband 115 from rubbing on the arm of the user due to force on the leash.

One of skill in the art will appreciate that the buckle 120 can be attached directly to the armband 115. Additionally or alternatively, the buckle 120 can be attached through other mechanisms or to other areas. For example, the buckle 120 can be attached to the pocket 215. Alternatively, the buckle 120 can be attached using a strip of fabric 220. The strip of fabric 220 can include the same material as the armband 115, the same material as the pocket 215, or can be made of a different fabric.

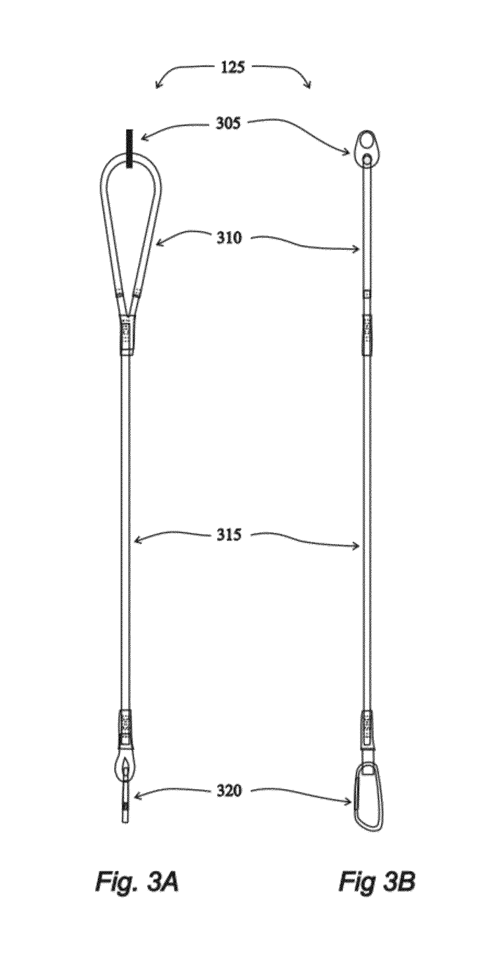

FIGS. 3A and 3B illustrate an example of a leash 125. FIG. 3A illustrates a front view of the leash 125; and FIG. 3B illustrates a side view of the leash 125. In at least one implementation, the leash 125 can be attached to the armband 115 of FIG. 1 and FIGS. 2A, 2B and 2C. In particular, the leash 125 can be attached, when needed, to restrain or control an animal and removed when the user desires to use the armband without restraining or controlling the animal.

FIG. 3 shows that the leash 125 can include an attachment 305. In at least one implementation, the attachment 305 can connect to a buckle on an armband such as the buckle 220 of FIGS. 2A, 2B and 2C. In particular, the attachment 305 can snap or otherwise attach to the buckle. This can allow the user to easily detach the leash 125 as desired.

FIG. 3 also shows that the leash 125 can include a loop 310. In at least one implementation, the loop 310 can be connected to the attachment 305. The loop 310 can allow the leash 125 to move relative to the armband, as described above. I.e., the connection between the loop 310 and the leash 125 can allow for freedom of movement between the leash 125 and the armband.

FIG. 3 further shows that the leash 125 can include a lead 315. In at least one implementation, the lead 315 can allow the armband to connect to the animal to be controlled or restrained without directly attaching to the animal. I.e., the lead 315 can allow the user to maintain control of the animal while still maintaining space between the user and the animal.

In at least one implementation, the lead 315 can include any material of sufficient strength to allow the user to control or restrain the animal. For example, the lead 315 can include nylon or shock cord. A shock cord, also known as a bungee cord, is an elastic cord composed of one or more elastic strands forming a core. The shock cord can also include a sheath. For example, the sheath can include a woven cotton or polypropylene sheath. One of skill in the art will appreciate that although the sheath may not materially extend elastically, it can be braided with its strands spiraling around the core so that a longitudinal pull causes it to squeeze the core, transmitting the core's elastic compression to the longitudinal extension of the sheath and cord. Additionally or alternatively, the shock cord can be made entirely of elastic strands.

FIG. 3 also shows that the leash 125 can include a fastener 320. In at least one implementation, the fastener 320 can connect the lead 315 to the animal to be controlled or restrained. The fastener 320 can be connected directly to the lead 315 or can be connected using some other method. For example, the fastener 320 can be passed through a loop on the end of the lead 315. In at least one implementation, the fastener 320 can include a carabiner. A carabiner or karabiner is a metal loop with a sprung or screwed gate. The gate can be opened such that the carabiner can be threaded through connection points to connect them to one another.

In at least one implementation, the fastener 320 can allow the leash 125 to be attached to the animal. For example, the lead 315 can be looped around the neck or body of the animal and the fastener 320 attached to the lead 315 to complete the loop. Additionally or alternatively, the fastener 320 can be connected to a collar, harness, halter, muzzle or other control device on the animal.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A hands free system for restraining an animal, the system comprising:
an armband, wherein the armband is configured to be attached around at least a portion of the arm of a user; and
a buckle, wherein the buckle is configured to connect to a leash, allowing the user to restrain an animal.

2. The system of claim 1, wherein the armband includes a pocket.

3. The system of claim 2, wherein the pocket is between 2.1 inches and 3.15 inches wide.

4. The system of claim 3, wherein the pocket is approximately 2.625 inches wide.

5. The system of claim 2, wherein the pocket is between 1.8 inches and 2.7 inches tall.

6. The system of claim 5, wherein the pocket is approximately 2.25 inches tall.

7. The system of claim 1, wherein the armband is between 10.4 inches and 15.6 inches wide.

8. The system of claim 7, wherein the armband is approximately 13 inches wide.

9. The system of claim 1, wherein the armband is between 2.4 inches and 3.6 inches tall.

10. The system of claim 9, wherein the armband is approximately 3 inches tall.

11. The system of claim 1, wherein the armband includes an attachment for connecting a first end of the armband to a second end of the armband.

12. The system of claim 11, wherein the attachment includes a hook and loop fastener.

13. A hands free system for restraining an animal, the system comprising:
an armband, wherein the armband:
is configured to be attached around at least a portion of the arm of a user; and
includes neoprene;
a buckle, wherein the buckle:
is attached to the armband;
is configured to connect to a leash; and
can swivel relative to the armband; and
the leash, wherein the leash:
is connected to the buckle; and
is capable of attaching to an animal or device for controlling the animal.

14. The system of claim 13, wherein the leash includes an attachment, wherein the attachment is configured to mate with the buckle.

15. The system of claim 13, wherein the leash includes a fastener for attaching to the animal or the device for controlling the animal.

16. The system of claim 15, wherein the fastener includes a carabiner.

17. A hands free system for restraining an animal, the system comprising:
an armband, wherein the armband:
is configured to be attached around at least a portion of the upper arm of a user;
includes neoprene; and
includes a pocket;
a buckle, wherein the buckle:
is attached to the armband;
is configured to connect to a leash;
can swivel relative to the armband; and
includes a quick release; and
the leash, wherein the leash is:
is connected to the buckle;
is capable of attaching to an animal or device for controlling the animal; and
includes an elastic portion.

18. The system of claim 17, wherein the leash includes a shock cord.

19. The system of claim 18, wherein the shock cord includes:
elastic fibers; and
a fabric sheath.

20. The system of claim 19, wherein the fabric sheath includes nylon.
